(19) United States
(12) Patent Application Publication
(10) Pub. No.: US 2010/0261428 A1
(43) Pub. Date: Oct. 14, 2010

(54) ROAD-VEHICLE COMMUNICATION SYSTEM

(75) Inventor: Souju Goto, Yokohama-shi (JP)

Correspondence Address: Robinson Intellectual Property Law Office, P.C., 3975 Fair Ridge Drive, Suite 20 North, Fairfax, VA, 22033, US

(73) Assignee: KABUSHIKI KAISHA KENWOOD, Hachiouji-shi, Tokyo (JP)

(21) Appl. No.: 12/746,976

(22) PCT Filed: Dec. 17, 2008
(86) PCT No.: PCT/JP2008/072985

§ 371 Date: Jun. 9, 2010

(30) Foreign Application Priority Data
Dec. 20, 2007 (JP) 2007-329039

(51) Int. Cl. H04B 7/00

(52) U.S. Cl. 455/41.2

(57) ABSTRACT

First and second roadside apparatuses for short-range communication with a vehicle-mounted device mounted in a vehicle are disposed upstream and downstream of a one-way road. The first and second roadside apparatuses installed on the road acquire vehicle identification information for identifying the vehicle when the vehicle passes through the communicative areas thereof. A administration device capable of communicating with the first and second roadside apparatuses stores the vehicle identification information acquired by the first roadside apparatus in a storage unit. If the vehicle identification information acquired by the second roadside apparatus is not included in the vehicle identification information stored in the storage unit, the administration device provides the vehicle with a reverse-way driving warning information through the second roadside apparatus. Thus, the road-vehicle communication system for warning a vehicle being driven or fully expected to be driven in the reverse-way on a one-way road such as a toll road against the reverse-way driving.

### TECHNICAL FIELD

The present invention relates to a road-vehicle communication system that prevents traveling in a reverse way on a toll road.

### BACKGROUND ART

Conventionally, there is known a road-vehicle communication system that includes a roadside apparatus installed on a road and a vehicle-mounted device mounted on a vehicle and performs two-way wireless communication between the roadside apparatus and the vehicle-mounted device. In this road-vehicle communication system, for example, a short-range communication system called DSRC (Dedicated Short Range Communication) is adopted.

The vehicle-mounted device is capable of performing the short-range wireless communication with the roadside apparatus and receiving information provision from a center apparatus via the roadside apparatus. Specifically, only in a period when the vehicle is within a communication range of the roadside apparatus, two-way communication between the vehicle-mounted device and the roadside apparatus is possible. Information is provided from the center apparatus to the vehicle-mounted device via the roadside apparatus in this period.

The road-vehicle communication system can provide the vehicle-mounted device with information for supporting traveling such as information indicating that there is an obstacle such as a stalled vehicle ahead on a road or there is a junction ahead. Therefore, the road-vehicle communication system is extremely effective for preventing traffic accidents.

Incidentally, in recent years, an accident of collision of a forward traveling vehicle and a reverse-way traveling vehicle in a one-way road such as a toll road (a reverse-way traveling accident) frequently occurs and poses a problem. This reverse-way traveling accident is caused by, for example, a vehicle entering the toll road from an exit ramp by mistake or traveling an entering path in a reverse way in returning from a service area or a parking area (hereafter referred to as SA/PA) to a main lane.

As a measure for preventing reverse-way traveling in the toll road, for example, attention is called by a road sign or a road surface display that indicates that a road is a one-way road. A technique for warning, using a road-vehicle communication system, a driver that the driver is traveling in a reverse way is proposed (e.g., Patent Document 1).

The road-vehicle communication system described in Patent Document 1 transmits entry information from a roadside apparatus to a vehicle-mounted device, for example, in an interchange of a toll road and outputs sound such as “enter a toll road” or “please be careful about a reverse-way traveling” to warn the driver and call attention of the driver to not travel in a reverse way.

### Patent Document 1: Japanese Patent Application Laid-Open No. 2007-102443

### DISCLOSURE OF THE INVENTION

### Problems to be Solved by the Invention

However, in the technique described in Patent Document 1, the entry information is transmitted to all vehicles passing through the vicinity of the roadside apparatus to perform warning for calling attention. Therefore, it is likely that this warning is annoying for a driver who is attempting to travel forward.

Therefore, if it is possible to perform warning for reverse-way traveling prevention only for vehicles that are extremely fully expected to travel a main lane of a toll road in a reverse way, for example, enter the main lane from an exit ramp by mistake or travel in a reverse way on an entering path of the SA/PA or vehicles that are traveling the main lane in a reverse way, it is possible to effectively prevent reverse-way traveling without giving an unpleasant feeling to a driver of a forward traveling vehicle.

It is an object of the present invention to provide a road-vehicle communication system that performs warning for reverse-way traveling prevention for vehicles that are traveling in a reverse way or vehicles that are extremely fully expected to travel in a reverse way in a one-way road such as a toll road.

### Means for Solving the Problems

In order to attain the object, a road-vehicle communication system according to the present invention basically includes: a first roadside apparatus that is provided on a one-way road and performs short-range communication with a vehicle-mounted device mounted on a vehicle; a second roadside apparatus that is provided on a downstream side of the first roadside apparatus and performs short-range communication with the vehicle-mounted device mounted on the vehicle; and an administration device that can communicate with the first roadside apparatus and the second roadside apparatus. The first roadside apparatus and the second roadside apparatus operate to acquire, when a vehicle passes through communicable ranges of the respective roadside apparatuses, vehicle identification information for identifying the vehicle. The administration device operates to store the vehicle identification information acquired by the first roadside apparatus in a storage unit, decide whether the vehicle identification information acquired by the second roadside apparatus is included in the vehicle identification information stored in the storage unit, and provide the vehicle with reverse-way traveling warning information via the second roadside apparatus when the vehicle identification information acquired by the second roadside apparatus is not included in the vehicle identification information stored in the storage unit.

In one aspect, the road-vehicle communication system according to the present invention is configured such that the administration device deletes, when the vehicle identification information acquired by the second roadside apparatus is included in the vehicle identification information stored in the storage unit, the vehicle identification information from the storage unit.

Further, preferably, in the road-vehicle communication system according to the present invention, the first roadside apparatus is installed in an entrance of an entering path for entering a parking area (SA/PA) from the main lane of the toll road, and the second roadside apparatus is installed in an exit of the entering path.

Further, a system may be configured in which the first roadside apparatus acquires, when a vehicle passes through the communicable range, vehicle type information for specifying a type of the vehicle, and the administration device stores the vehicle identification information and the vehicle type information acquired by the first roadside apparatus, defines a type of the vehicle (a large-sized vehicle, medium/small-sized vehicles, a handicapped driver vehicle, etc.) on the basis of the vehicle type information, and provides the vehicle with leading guide information corresponding to the vehicle when the vehicle identification information acquired by the second roadside apparatus is included in the vehicle identification information acquired from the first roadside apparatus.

In the road-vehicle communication system according to the present invention, the second roadside apparatus may be configured to include the administration device.

Further, in the road-vehicle communication system according to the present invention, the vehicle identification information or the vehicle type information may be stored in the vehicle-mounted device mounted on the vehicle.

### Effects of the Invention

With the road-vehicle communication system according to the present invention, the road-vehicle communication system performs warning for reverse-way traveling prevention for vehicles that are traveling in a reverse way or vehicles that are extremely fully expected to travel in a reverse way in a one-way road such as a toll road. Therefore, it is possible to effectively prevent a reverse-way traveling accident in the one-way road.

### BRIEF DESCRIPTION OF THE DRAWINGS

FIG. 1 is a schematic diagram showing an example of an installation state of a road-vehicle communication system according to the present invention;

FIG. 2 is an explanatory diagram of a roadside area that is a communicable range of a roadside apparatus;

FIG. 3 is an explanatory diagram showing a configuration example of the road-vehicle communication system;

FIG. 4 is a block diagram showing a configuration example of a vehicle-mounted device mounted on a vehicle;

FIG. 5 is a flowchart showing an example of information providing processing according to the present invention;

FIG. 6 is an explanatory diagram showing an example of a data structure of passing vehicle information stored in a RAM;

FIG. 7 is an explanatory diagram showing a display example of leading guide output to a display of a car navigation section;

FIG. 8 is an explanatory diagram showing a display example of reverse-way traveling warning output to the display of the car navigation section; and

FIG. 9 is a schematic diagram showing another configuration example of the road-vehicle communication system.

### DESCRIPTION OF SYMBOLS

1 first roadside apparatus
11 control section
111 CPU
112 ROM
113 RAM
12 DSRC communication unit
13 network communication unit
2 second roadside apparatus
21 control section (administration device)
211 CPU
212 ROM
213 RAM (storage unit)
22 DSRC communication unit
23 network communication unit
24 provided information storage unit
3 vehicle-mounted device
100 road-vehicle communication system

### BEST MODES FOR CARRYING OUT THE INVENTION

An embodiment of the present invention is explained below on the basis of the drawings.

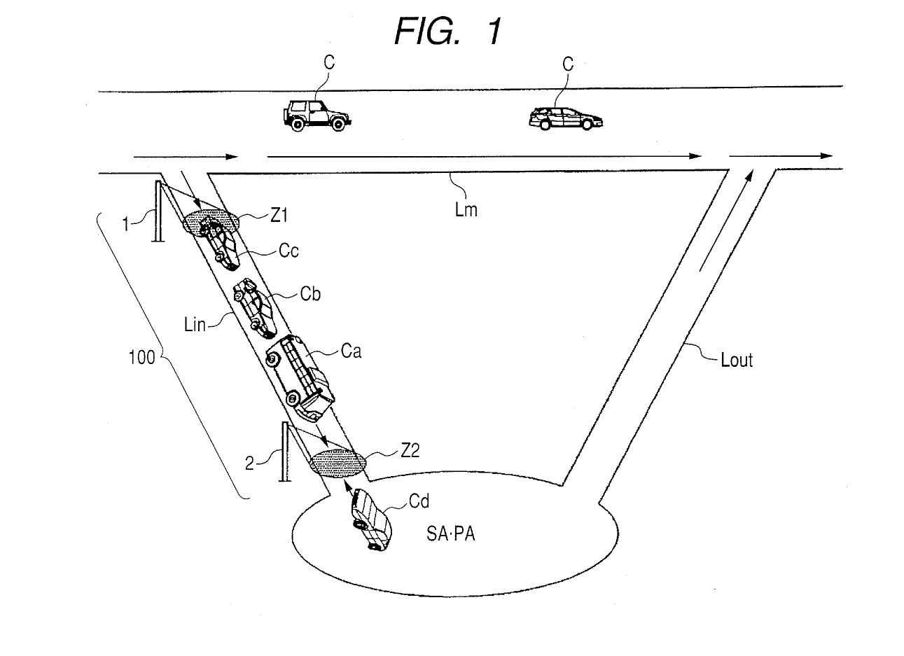

FIG. 1 is a schematic diagram showing an example of an installation state of a road-vehicle communication system according to the present invention.

As shown in FIG. 1, a road-vehicle communication system 100 according to this embodiment includes a first roadside apparatus 1 installed in an entrance of an entering path Lin from a main lane Lm to a service area or a parking area (hereafter referred to as SA/PA) and a second roadside apparatus 2 installed on the SA/PA side.

At different two points in a one-way road, the point through which a vehicle passes earlier is represented as upstream side and the point through which the vehicle passes later is represented as downstream side. Specifically, in the entering path Lin, the second roadside apparatus 2 is installed on the downstream side of the first roadside apparatus 1.

In the following explanation, when a roadside apparatus is simply described as a roadside apparatus, this indicates that the roadside apparatus is a roadside apparatus used in a general road-vehicle communication system (the first roadside apparatus 1 and the second roadside apparatus 2 are also included in the roadside apparatus).

In the main lane Lm of the toll road, vehicles C, C, . . . travel in one direction. When the vehicle C traveling the main lane Lm enters a parking area such as the SA/PA, the vehicle C travels an entering path Lin that branches to the right side from the main lane Lm (vehicles Ca, Cb, and Cc). When the vehicle C returns from the SA/PA to the main lane Lm, usually, the vehicle C travels an exiting path Lout that merges into the main lane Lm from the right side.

On the other hand, when a vehicle Cd that travels the entering path Lin and arrives at the SA/PA attempts to travel the entering path Lin and return to the main lane Lm, this vehicle Cd travels the entering path Lin in a reverse way. The vehicle Cd is extremely fully expected to travel the main lane in a reverse way as well.

The road-vehicle communication system 100 according to this embodiment performs reverse-way traveling warning for a vehicle extremely fully expected to travel the entering path Lin in a reverse way and travel the main lane Lm in a reverse way (e.g., the vehicle Cd) and prevents a reverse-way traveling accident from occurring in the toll road.

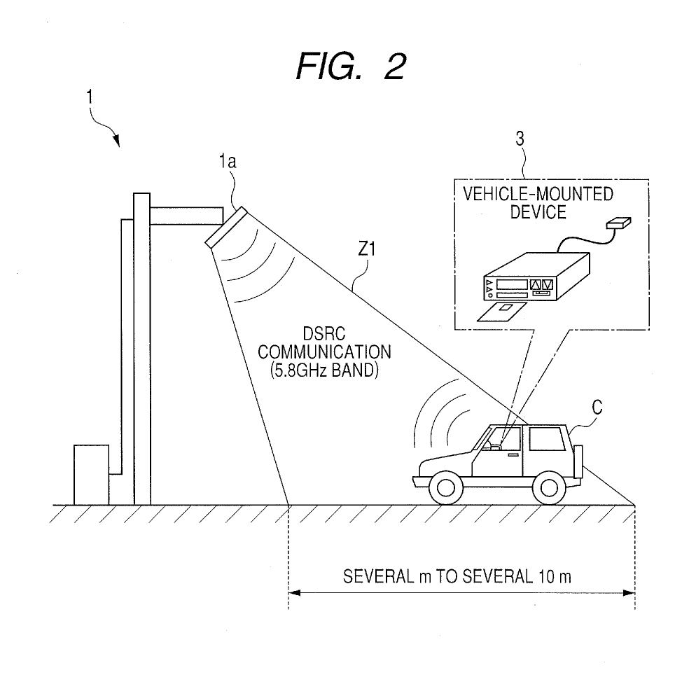

FIG. 2 is an explanatory diagram of a roadside area that is a communicable range of a roadside apparatus. The first roadside apparatus 1 is shown in FIG. 2.

As shown in FIG. 2, the first roadside apparatus 1 radiates a DSRC radio wave having a limited reaching distance from an antenna 1a installed beside a road or above the road and forms a roadside area Z1 near the roadside apparatus. The DSRC is a short-range communication system employing a radio wave in a 5.8 GHz band. A communication range of the DSRC is set to, for example, several meters to several tens of meters.

In general, in a road-vehicle communication system, a plurality of roadside apparatuses are installed. However, since all outputs of DSRC radio waves from the roadside apparatuses are set to the same degree, roadside areas respectively formed by the plurality of roadside apparatuses are substantially fixed irrespectively of installing locations.

In this embodiment, the first roadside apparatuses 1 and the second roadside apparatus 2 form equivalent roadside areas Z1 and Z2 (see FIG. 1). The first roadside apparatus 1 and the second roadside apparatus 2 can perform two-way wireless communication (road-vehicle communication) with only vehicle-mounted devices 3 mounted on the vehicles C present in the respective roadside areas Z1 and Z2.

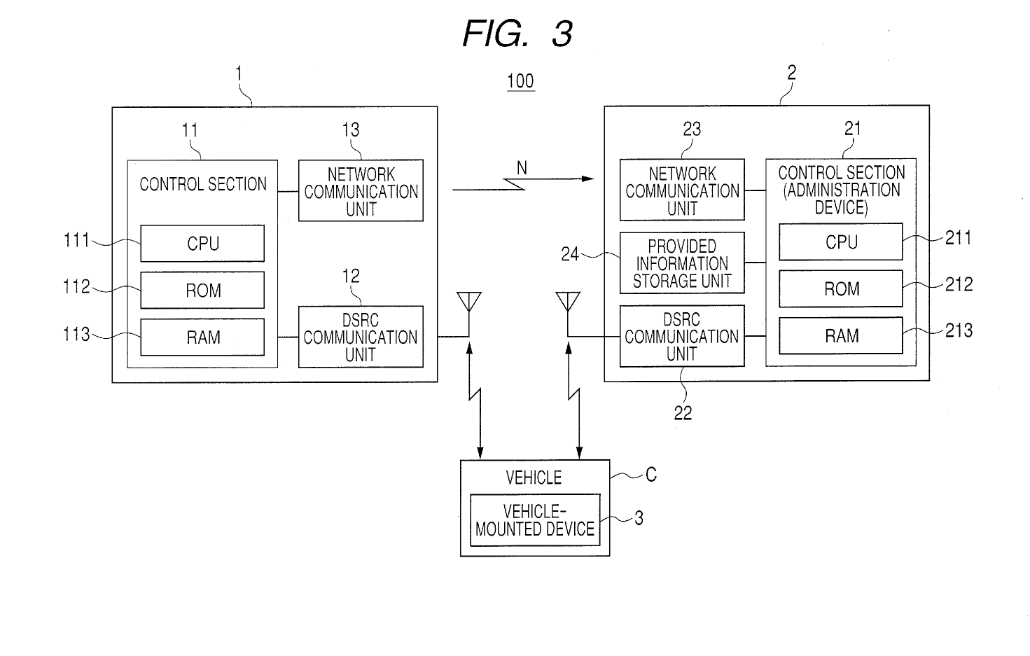

FIG. 3 is an explanatory diagram showing a configuration example of the road-vehicle communication system 100. Specifically, the first roadside apparatus 1 and the second roadside apparatus include processing apparatuses (e.g., computer terminals) including functional blocks shown in FIG. 3.

As shown in FIG. 3, the road-vehicle communication system 100 includes the first roadside apparatus 1 and the second roadside apparatus 2, each of which performs road-vehicle communication by DSRC with the vehicle-mounted device 3 mounted on the vehicle C.

The first roadside apparatus 1 includes a control section 11, a DSRC communication unit 12, and a network communication unit 13.

The control section 11 includes a CPU 111, a ROM 112, and a RAM 113. The CPU 111 executes, using the RAM 113 as a work area, a control program stored in the ROM 112 to thereby control the DSRC communication unit 12 and the network communication unit 13 besides performing various arithmetic operations.

The DSRC communication unit 12 performs transmission and reception of information with the vehicle-mounted device 3 mounted on the vehicle C through the DSRC. For example, the DSRC communication unit 12 always transmits a DSRC radio wave for requesting vehicle type information for defining a type of a vehicle (a large-sized vehicle, medium/small-sized vehicles, a handicapped driver vehicle, etc.) and vehicle identification information for identifying a vehicle to the vehicle-mounted device 3. The vehicle type information and the vehicle identification information are hereafter collectively referred to as information concerning a vehicle.

When the vehicle C passes through the roadside area Z1 of the first roadside apparatus 1, since vehicle the information concerning a vehicle is transmitted from the vehicle-mounted device 3 mounted on the vehicle C in response to this request, the DSRC communication unit 12 receives this information.

The network communication unit 13 performs transmission and reception of information with the second roadside apparatus 2 via a network N. For example, when the network communication unit 13 acquires the information concerning a vehicle from the vehicle-mounted device 3, the network communication unit 13 immediately transmits this information to the second roadside apparatus 2.

This information concerning a vehicle is accumulated in the second roadside apparatus 2 and used to monitor whether the vehicle C passing through the entrance of the entering path Lin normally passes through the exit and enters the SA/PA and the vehicle C entering the SA/PA travels the entering path Lin in a reverse way and attempts to enter the toll road.

The second roadside apparatus 2 includes a control section 21, a DSRC communication unit 22, a network communication unit 23, and a provided information storage unit 24. The second roadside apparatus 2 is different from the first roadside apparatus 1 in that the second roadside apparatus 2 includes the provided information storage unit 24.

The control section 21 includes a CPU 211, a ROM 212, and a RAM 213. The CPU 211 executes, using the RAM 213 as a work area, a control program stored in the ROM 212 to thereby control the DSRC communication unit 22 and the network communication unit 23 besides performing various arithmetic operations.

For example, the CPU 211 executes an information providing processing program stored in the ROM 212 to thereby store the information concerning a vehicle transmitted from the first roadside apparatus 1 in the RAM 213. The CPU 211 compares the information stored in the RAM 213 and information concerning a vehicle acquired by the DSRC communication unit 22 explained later to thereby define the vehicle C passing through the roadside area Z2 of this second roadside apparatus 2 and provide predetermined information. Information providing processing is explained in detail later.

As explained above, since the control section 21 receives information from the first roadside apparatus 1 and performs exchange of information in the second roadside apparatus 2, it can be said that the control section 21 is configured to be capable of communicating with the first roadside apparatus 1 and the second roadside apparatus 2. In other words, the control section 21 configures an administration device in the present invention.

A function of the administration device is imparted the second roadside apparatus 2, whereby time required for information communication is reduced. This makes it possible to instantaneously provide reverse-way traveling warning information when a reverse-way traveling vehicle passes the roadside area Z2 of the second roadside apparatus 2.

The DSRC communication unit 22 performs transmission and reception of information with the vehicle-mounted device 3 mounted on the vehicle C through the DSRC. For example, the DSRC communication unit 22 always transmits a DSRC radio wave for requesting information concerning a vehicle to the vehicle-mounted device 3. The second roadside apparatus 2 may request only the vehicle identification information as the information concerning a vehicle.

When the vehicle C passes through the roadside area Z2 of the second roadside apparatus 2, since information concerning a vehicle is transmitted from the vehicle-mounted device 3 mounted on the vehicle C in response to this request, the DSRC communication unit 22 receives this information.

In information providing processing executed by the CPU 211, the DSRC communication unit 22 transmits predetermined information to the vehicle C passing through the roadside area Z2.

The network communication unit 23 performs transmission and reception of information with the first roadside apparatus 1 via the network N. For example, the network communication unit 23 receives the information concerning a vehicle transmitted from the first roadside apparatus 1.

The provided information storage unit 24 includes, for example, a nonvolatile memory and stores information provided to the vehicle C in the information providing processing. For example, the provided information storage unit 24 stores leading guide information including video information (leading guides 1 and 2, etc. explained later) for visually leading a large-sized vehicle, a medium/small-sized vehicle, a handicapped driver vehicle, and the like to respective parking areas in the SA/PA. The provided information storage unit 24 stores reverse-way traveling warning information for visually alerting a vehicle traveling the entering path Lin in a reverse way that the vehicle is traveling in a reverse way.

In the information providing processing executed by the CPU 211, the leading guide information is stored in association with the information concerning a vehicle when the vehicle C passes through the roadside area Z1 and is transmitted when this vehicle C passes through the roadside area Z2. In the information providing processing, when the vehicle C traveling in a reverse way and passing through the roadside area Z2 is detected, the reverse-way traveling warning information is transmitted to this vehicle C.

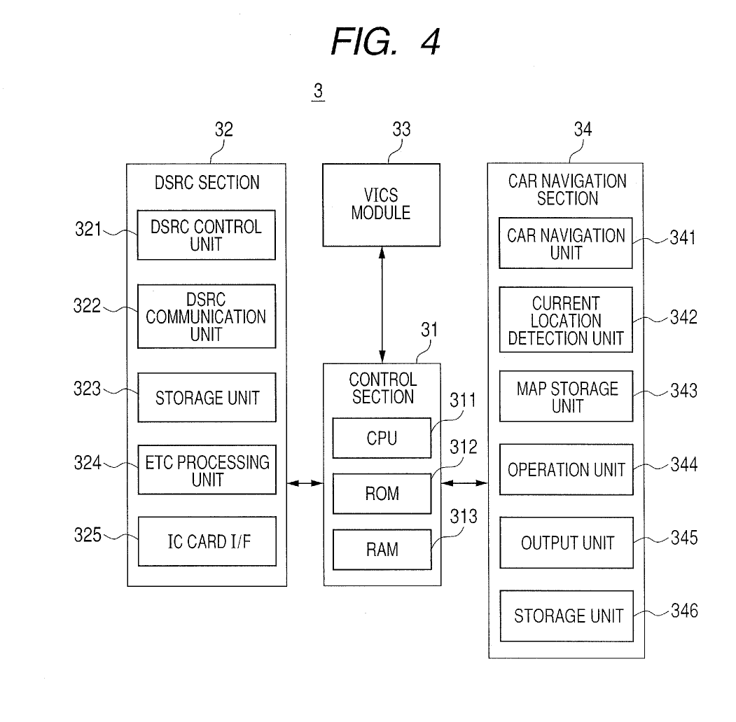

FIG. 4 is a block diagram showing a configuration example of the vehicle-mounted device 3 mounted on the vehicle C.

The vehicle-mounted device 3 is an ITS vehicle-mounted device applicable to an ITS (Intelligent Transport System). For example, in the conventional road-vehicle communication system, the vehicle-mounted device 3 receives content information or the like transmitted from a center apparatus via a roadside apparatus and stores or outputs the content information or the like.

Further, in the road-vehicle communication system 100 according to this embodiment, the vehicle-mounted device 3 performs communication by the DSRC with the first roadside apparatus 1 and the second roadside apparatus 2 and transmits information concerning a vehicle v to the first roadside apparatus 1 and the second roadside apparatus 2. On the other hand, the vehicle-mounted device 3 receives provided information transmitted from the second roadside apparatus 2 and outputs the provided information.

As shown in FIG. 4, the vehicle-mounted device 3 includes a control section 31, a DSRC section 32, a VICS module 33, and a car navigation section 34.

The control section 31 includes a CPU 311, a ROM 312, and a RAM 313. The CPU 311 executes, using the RAM 313 as a work area, a control program stored in the ROM 312 to thereby perform concentrated control of the sections besides performing various arithmetic operations.

For example, when the control section 31 performs the communication by the DSRC with the first roadside apparatus 1 and the second roadside apparatus 2, the CPU 311 controls communication operation of the DSRC section 32. In the control of the DSRC section 32, the CPU 311 performs the control in cooperation with a DSRC control unit 321 of the DSRC section 32.

Specifically, when the DSRC radio wave for requesting information concerning a vehicle always originated from the first roadside apparatus 1 or the second roadside apparatus 2 is received in the DSRC section 32, the CPU 311 controls the DSRC section 32 to transmit this information to the first roadside apparatus 1 or the second roadside apparatus 2.

When provided information transmitted from the second roadside apparatus 2 is received in the DSRC section 32, the CPU 311 controls the car navigation section 34 to output this provided information.

The DSRC section 32 includes the DSRC control unit 321, a DSRC communication unit 322, a storage unit 323, an ETC processing unit 324, and an IC card interface 325. The DSRC section 32 performs processing for communicating with a roadside apparatus and an ETC base station through the DSRC.

The DSRC control unit 321 includes a CPU, a ROM, and a RAM (all of which are not shown in the figure) and controls the operation of the units of the DSRC section 32 in cooperation with a control program stored in the ROM.

For example, when payment by the ETC (Electronic Toll Collection) is performed, the DSRC control unit 321 controls communication operation of the DSRC communication unit 322 to perform transmission and reception of payment information with the ETC base station (a radio base station provided, for example, near an ETC gate in order to perform ETC payment). The DSRC control unit 32 controls the ETC processing unit 324 to perform processing for writing the payment information in an IC of a credit card or the like.

For example, if content information is received by the DSRC communication unit 322 from a center apparatus via a roadside apparatus, the DSRC control unit 321 transfers the content information to the control section 31. If provided information is received by the DSRC communication unit 322 via the second roadside apparatus 2, the DSRC control unit 321 transfers the provided information to the control section 31.

The DSRC communication unit 322 includes an antenna installed on the dashboard and near the windshield of the vehicle C. The DSRC communication unit 322 performs communication by the DSRC with the roadside apparatus and the ETC base station via this antenna.

The storage unit 323 includes, for example, a nonvolatile memory and stores a vehicle-mounted device ID attached to the vehicle-mounted device 3, vehicle information concerning the vehicle C mounted with the vehicle-mounted device 3, and the like.

The vehicle-mounted device ID is vehicle-mounted device information attached to each vehicle-mounted device during manufacturing. The vehicle information includes license plate information and vehicle type information (a large-sized vehicle, a medium-sized vehicle, a small-sized vehicle, a handicapped driver vehicle, etc.) of the vehicle C mounted with the vehicle-mounted device 3. The vehicle information is registered when the vehicle-mounted device 3 is mounted on the vehicle C (setup).

The vehicle-mounted device ID and/or the vehicle information are transmitted to the first roadside apparatus 1 and the second roadside apparatus 2 as information concerning a vehicle. In particular, the vehicle-mounted device ID or the license plate information is vehicle identification information for identifying a vehicle.

Since the first roadside apparatus 1 and the second roadside apparatus 2 acquire the vehicle-mounted device ID or the license plate information as the vehicle identification information, it is possible to accurately define the vehicle C passing through the roadside area Z1 or Z2 of the first roadside apparatus 1 or the second roadside apparatus 2.

The ETC processing unit 324 writes the payment information or the like in and reads the payment information or the like from a credit card, a debit card, or the like with an IC inserted into and removed from the IC card interface 325.

The IC card interface includes a slot for a credit card and the like and mediates exchange of information between an IC of a credit card or the like inserted into this slot and the ETC processing unit.

The VICS module 33 includes antennas respectively for optical communication, FM communication, and 2.4 GHz radio wave communication and performs the optical communication, the FM communication, and the radio wave communication with a VICS (Vehicle Information and Communication System) center. The VICS module 33 receives traffic jam information, road traffic information, or the like from the VICS center and transfers the information to the control section 31.

The car navigation section 34 includes a car navigation unit 341, a current location detection unit 342, a map storage unit 343, an operation unit 344, an output unit 345, and a storage unit 346. The car navigation section 34 performs processing for guiding the vehicle C to a guide path.

The car navigation unit 341 calculates, on the basis of information concerning a current location acquired from the current location detection unit 342, map information stored in the map storage unit 343, and the like, a guide path from the current location of the vehicle C to a destination set via the operation unit 344. The car navigation unit 341 generates, using the map information stored in the map storage unit 343, a map screen for leading the vehicle C to the calculated guide path and causes a display of the output unit 345 to display the map screen.

The current location detection unit 342 includes a GPS (Global Positioning System) and a gyro sensor.

The GPS receives a GPS signal transmitted from a GPS satellite and calculates an own-vehicle location (the latitude and the longitude) on the basis of the GPS signal.

The gyro sensor detects acceleration (rotating speed in the horizontal direction per unit time) of a vehicle indicating an amount of change in a moving direction (an angular velocity sensor) and performs detection of geomagnetism (an azimuth sensor) to detect an absolute azimuth of the own vehicle.

The current location detection unit 342 generates, on the basis of information acquired from the GPS and the gyro sensor, current location information (information concerning the latitude, the longitude, etc.) indicating the current location of the vehicle and information concerning traveling speed and transfers the information to the car navigation unit 341.

The map storage unit 343 includes a storage medium such as a hard disk or a DVD and stores map information necessary for guidance display.

The operation unit 344 includes hard keys provided in a main body of the vehicle-mounted device, a touch panel (soft keys) integrally provided in the display of the output unit 345, or a remote controller. When key operation is performed by a user, the operation unit 344 generates an operation signal corresponding to this operation and outputs the operation signal to the control section 31.

The output unit 345 includes a display and a loudspeaker. The display performs screen display guidance according to the control by the control section 31. The output unit 345 displays, for example, a setting screen, a map screen, and a display screen for content information received from the center apparatus of the road-vehicle communication system. The loudspeaker performs sound guidance according to the control by the control section 31.

The storage unit 346 includes, for example, a readable and writable semiconductor memory. The storage unit 346 stores, for example, a guide information (road information, traffic jam information, etc.) received via the VICS module 33 and a traveling history of a vehicle.

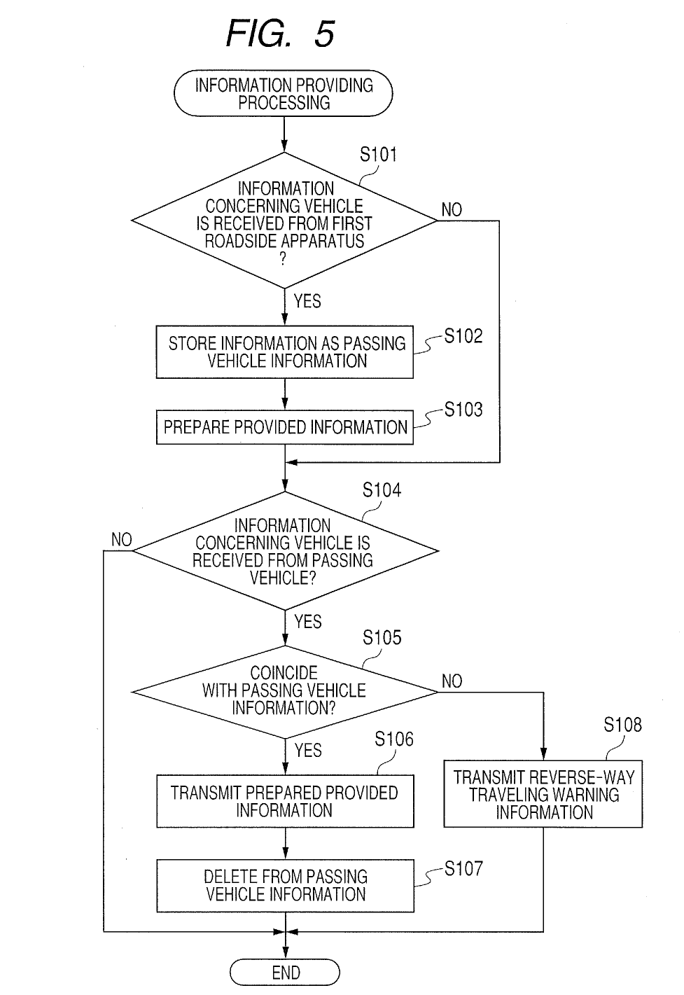

FIG. 5 is a flowchart showing an example of information providing processing according to the present invention. In this embodiment, this information providing processing is realized by the CPU 211 executing an information providing processing program in the ROM 212 in the second roadside apparatus 2.

In step S101, the CPU 211 decides whether information concerning a vehicle is acquired from the first roadside apparatus 1. For example, when information concerning a vehicle is acquired from the vehicle C passing through the roadside area Z1 in the first roadside apparatus 1, this information is transmitted to the second roadside apparatus 2 and received in the second roadside apparatus 2.

If the CPU 211 decides that the information concerning a vehicle is received from the first roadside apparatus 1, the CPU 211 shifts to step S102. If the CPU 211 decides that the information concerning a vehicle is not received, the CPU 211 shifts to step S104.

In step S102, the CPU 211 stores the information concerning a vehicle transmitted from the first roadside apparatus 1 in the RAM 213 as passing vehicle information. Specifically, the CPU 211 stores information concerning the vehicle C entering the entering path Lin from the main lane Lm of the toll road.

In step S103, when the passing vehicle information is stored in the RAM 213 anew, the CPU 211 stores provided information in association with the passing vehicle information and prepares information to be provided to the vehicle C passing through the roadside area Z2 of the second roadside apparatus 2. For example, if vehicle type information included in the passing vehicle information stored anew is “large-sized vehicle”, the CPU 211 stores information for leading and guiding the large-sized vehicle to a parking area for the large-sized vehicle in association with vehicle information.

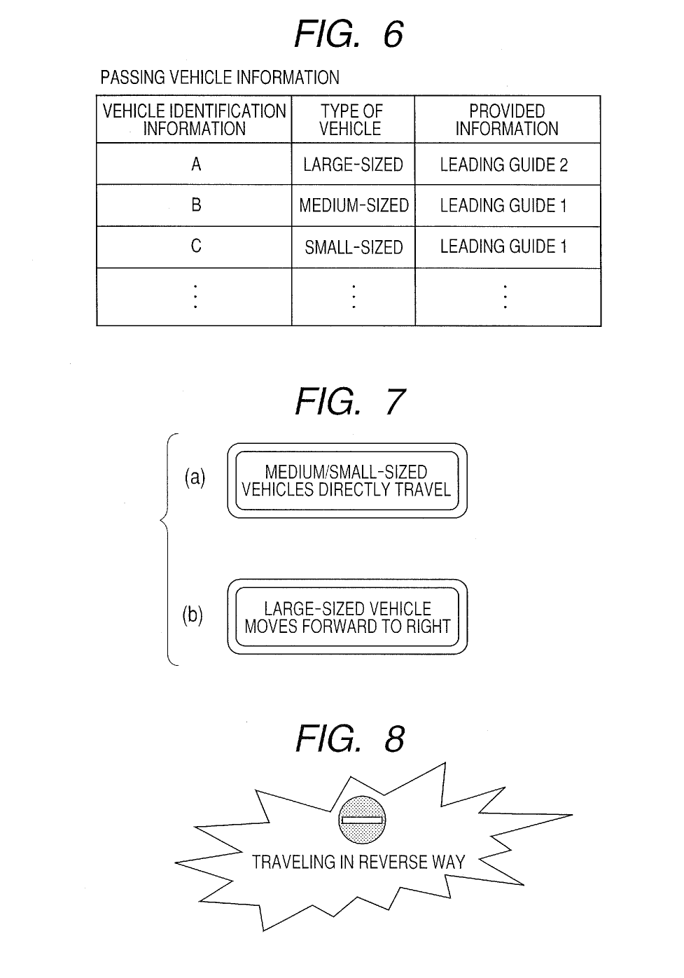

FIG. 6 is an explanatory diagram showing an example of a data structure of passing vehicle information stored in the RAM 213. In FIG. 6, passing vehicle information obtained when the vehicles Ca, Cb, and Cc enter the entering path Lin from the main lane Lm as shown in FIG. 1 is shown.

Specifically, Concerning the passing vehicle Ca, vehicle identification information “A”, vehicle type information “large-sized”, and provided information “leading guide 2” are stored in association with the passing vehicle Ca. Similarly, concerning the passing vehicle Cb, vehicle identification information “B”, vehicle type information “medium-sized”, and provided information “leading guide 1” are stored in association with the passing vehicle Cb. Concerning the passing vehicle Cc, vehicle identification information “C”, vehicle type information “small-sized”, and provided information “leading guide 1” are stored in association with the passing vehicle Cc.

The leading guide 1 and the leading guide 2 as the provided information are provided information stored in the provided information storage unit 24.

In FIG. 5, in step S104, the CPU 211 decides whether information concerning a vehicle (vehicle identification information) is received from the vehicle C passing through the roadside area Z2 in the second roadside apparatus 2. If the CPU 211 decides that the information concerning a vehicle is received from the vehicle C passing through the roadside area Z2, the CPU 211 shifts to step S105. If the CPU 211 decides that the information concerning a vehicle is not received, the CPU 211 directly ends the processing.

In step S105, the CPU 211 compares the vehicle identification information stored in the RAM 213 as the passing vehicle information and the vehicle identification information acquired from the vehicle C passing through the roadside area Z2 and decides whether the vehicle C passing through the roadside area Z2 is a vehicle passing through the roadside area Z1.

If the CPU 211 decides that the vehicle C is the vehicle passing through the roadside area Z1, i.e., if the CPU 211 decides that the vehicle C is a vehicle traveling forward the entering path Lin, the CPU 211 shifts to step S106. On the other hand, if the CPU 211 decides that the vehicle C is not the vehicle passing through the roadside area Z1, i.e., if the CPU 211 decides that the vehicle C is a vehicle traveling the entering path Lin in a reverse way, the CPU 211 shifts to step S108.

In step S106, the CPU 211 transmits the prepared provided information to the vehicle-mounted device 3 of the vehicle. Specifically, the CPU 211 refers to the provided information stored in the RAM 213 as the passing vehicle information and transmits provided information corresponding to the vehicle.

For example, when the passing vehicle information shown in FIG. 6 is stored in the RAM 213, when the vehicle Ca passes through the roadside area Z2, the leading guide 2 for leading and guiding a large-sized vehicle is transmitted. In the vehicle-mounted device 3 mounted on the vehicle Ca, the car navigation section 34 performs output based on the leading guide 2. For example, a screen shown in FIG. 7(b) is displayed on a display of the output unit 345 of the car navigation section 34. According to this screen display, a driver can learn that the driver can reach the parking area for a large-sized vehicle by moving forward to the right side.

For example, when the passing vehicle information shown in FIG. 6 is stored in the RAM 213, when the vehicle Cb passes through the roadside area Z2, the leading guide 1 for leading and guiding a medium-sized vehicle is transmitted. In the vehicle-mounted device 3 mounted on the vehicle Cb, the car navigation section 34 performs output based on the leading guide 1. For example, a screen shown in FIG. 7(a) is displayed on the display of the output unit 345 of the car navigation section 34. According to this screen display, a driver can learn that the driver can reach the parking area for medium/small-sized vehicles by directly advancing.

As explained above, in this embodiment, the second roadside apparatus 2 stores vehicle identification information and vehicle type information acquired by the first roadside apparatus 1 and defines a type (a large-sized vehicle, a small-sized vehicle, a handicapped driver vehicle, etc.) of the vehicle C on the basis of the vehicle type information. If the vehicle identification information acquired by the second roadside apparatus is included in the vehicle identification information acquired from the first roadside apparatus 1, the second roadside apparatus 2 provides leading guide information corresponding to the vehicle C.

Specifically, the second roadside apparatus 2 leads and guides the vehicle C traveling forward the entering path Lin and entering the SA/PA to a parking area for the vehicle C. Consequently, it is possible to prevent a collision accident or a traffic jam from occurring in the SA/PA because a driver not frequently using the SA/PA strays for a parking area.

In FIG. 5, in step S107, the CPU 211 deletes information corresponding to the vehicle passing through the roadside area Z2 of the second roadside apparatus 2 from the passing vehicle information stored in the RAM 213.

Consequently, when a vehicle normally entering the SA/PA travels in a reverse way and enters the entering path Lin from the SA/PA, it is possible to judge that the vehicle is a reverse-way traveling vehicle. Since passing vehicle information for the number of vehicles that can simultaneously park on the entering path Lin may be stored in the RAM 213, a storage area can be efficiently used. For example, it is sufficient to secure, in the RAM 213, a storage area that can store passing vehicle information for the number of vehicles about twice as large as the number of vehicles that can simultaneously park on the entering path Lin.

In step S108, the CPU 211 transmits the reverse-way traveling warning information stored in the provided information storage unit 24 to the vehicle-mounted device 3 of the vehicle C. As explained above, when the vehicle C normally enters the SA/PA, the passing vehicle information corresponding to the vehicle C is deleted from the RAM 213. Therefore, concerning the vehicle C traveling in a reverse way and entering the entering path Lin from the SA/PA, passing vehicle information of the vehicle C is not stored in the RAM 213. Therefore, the CPU 211 provides such a vehicle (the vehicle Cd shown in FIG. 1) of reverse-way traveling warning information for warning that the vehicle is traveling in a reverse way.

For example, when the passing vehicle information shown in FIG. 6 is stored in the RAM 213, when the vehicle Cd passes through the roadside area Z2, since information concerning the vehicle Cd is not included in the passing vehicle information, the CPU 211 transmits reverse-way traveling warning information. In the vehicle-mounted device 3 mounted on the vehicle Cd, the car navigation section 34 performs output based on the reverse-way traveling warning information. For example, a screen shown in FIG. 8 is displayed on the display of the output unit 345 of the car navigation section 34. According to this screen display, a driver can learn that the own vehicle is traveling in a reverse way and turns back to the SA/PA before merging into the main lane Lm. Therefore, it is possible to prevent a reverse-way traveling accident from occurring on the main lane Lm.

When there is a vehicle traveling forward and attempting to enter the SA/PA on the entering path Lm, since a traveling direction of the vehicle can be easily recognized, an event in which the vehicle travels the entering path Lin in a reverse way from the SA/PA and merges into the main lane hardly occurs. In other words, when the vehicle C is provided with the reverse-way traveling warning information, since the entering path Lin is considered to be not crowded, the vehicle C can make a U-turn and easily turn back to the SA/PA.

As explained above, the road-vehicle communication system 100 according to this embodiment includes the first roadside apparatus 1 that is provided on the entering path (the one-way road) Lin from the main lane Lm of the toll road to the SA/PA and performs short-range communication with the vehicle-mounted device 3 mounted on the vehicle C and the second roadside apparatus 2 that is provided on the downstream side of the first roadside apparatus 1 and performs short-range communication with the vehicle-mounted device 3 mounted on the vehicle C. When the vehicle C passes the roadside areas (the communicable ranges) Z1 and Z2 of the first roadside apparatus 1 and the second roadside apparatus 2, the first roadside apparatus 1 and the second roadside apparatus 2 acquire vehicle identification information (a vehicle-mounted device ID and license plate information) for defining the vehicle C.

On the other hand, the second roadside apparatus as the administration device stores the vehicle identification information acquired by the first roadside apparatus 1 in the RAM (the storage unit) 213 as passing vehicle information (step S102 in FIG. 5) and determines whether the vehicle identification information acquired by the second roadside apparatus 2 is included in the vehicle identification information stored in the RAM 213 (step S105 in FIG. 5).

If the vehicle identification information acquired by the second roadside apparatus 2 is not included in the vehicle identification information (the passing vehicle information) stored in the RAM 213, the second roadside apparatus 2 provides the vehicle C with the reverse-way traveling warning information.

Therefore, with the road-vehicle communication system 100 according to the present invention, it is possible to judge, according to a traveling form on the entering path Lin, the vehicle C extremely fully expected to travel the main lane Lm of the toll road or the like in a reverse way and it is possible to perform warning for reverse-way traveling prevention for this vehicle C. Therefore, it is possible to effectively prevent a reverse-way traveling accident.

The road-vehicle communication system 100 performs warning for reverse-way traveling prevention only for a vehicle extremely fully expected to travel the main lane Lm of the toll road in a reverse way. Therefore, it is unlikely to give unpleasant feeling to a driver of a vehicle traveling forward by thoughtlessly warning the driver.

In particular, on the entering path Lin to the SA/PA, the vehicle C travels at low speed compared with speed during traveling on the main lane. Therefore, it is considered to be possible to avoid a reverse-way traveling accident if it is possible to warn the vehicle C about reverse-way traveling before merging into the main lane Lm.

The invention devised by the inventor has been specifically explained on the basis of the embodiment. However, the present invention is not limited to the embodiment and can be changed in a range without departing from the spirit of the present invention.

For example, the road-vehicle communication system according to the present invention can be applied not only in the entering path Lin from the main lane Lm of the toll road to the SA/PA but also in an exiting path from the main lane Lm of the toll road to an exit ramp. In this case, the first roadside apparatus is provided on an entrance side (the main lane side) upstream of the exiting path and the second roadside apparatus is provided on an exit side (near the exit ramp) downstream of the exiting path.

The road-vehicle communication system according to the present invention can also be applied in the main lane Lm of the toll road. Consequently, it is possible to perform reverse-way traveling warning for the vehicle C actually traveling the main lane Lm in a reverse way. Since the reverse-way traveling warning is not performed on the entering path Lin entering from the main lane Lm to the SA/PA or near the exit ramp to prevent reverse-way traveling itself on the main lane Lm, it is less likely that a reverse-way traveling accident can be prevented. However, since a vehicle actually traveling the main lane Lm in a reverse way is extremely dangerous, it is useful to warn the vehicle that the vehicle is traveling in a reverse way.

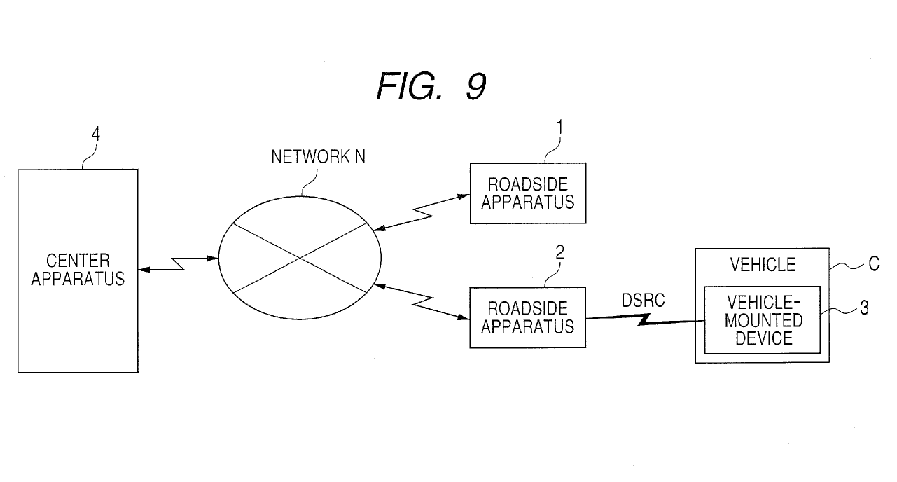

In the embodiment, the second roadside apparatus includes the administration device. However, as shown in FIG. 9, a center apparatus 4 as an administration device may be separately provided on the network N to enable the center apparatus 4 and the first roadside apparatus 1 and the second roadside apparatus 2 to communicate with each other. In this case, the center apparatus executes processing equivalent to the information providing processing shown in FIG. 5.

The vehicle-mounted device 3 may output sound from the loudspeaker on the basis of the leading guide information or the reverse-way traveling warning information rather than simply outputting a video to the display of the output unit 345 of the car navigation section 34. This can be easily realized if the leading guide information and the reverse-way traveling warning information include sound information.

In the embodiment, the first roadside apparatus 1 and the second roadside apparatus 2 acquires the vehicle-mounted device ID stored in the vehicle-mounted device 3 or the vehicle information (including the license plate information and the vehicle type information) as information concerning a vehicle. However, the vehicle identification information or the vehicle type information may be acquired by other means. For example, it is possible to identify, using various sensors and an imaging apparatus, a vehicle on the basis of information acquired from the sensors and the imaging apparatus and define a type of a vehicle.

The embodiment disclosed herein should be considered illustrative in every aspect and not limiting. The scope of the present invention is indicated by the scope of the patent claims rather than the above explanation. It is intended that all changes within meanings and scopes equivalent to the scope of the patent claims are included in the present invention.

1. A road-vehicle communication system comprising:
a first roadside apparatus that is provided on a one-way road and performs short-range communication with a vehicle-mounted device mounted on a vehicle;
a second roadside apparatus that is provided on a downstream side of the first roadside apparatus and performs short-range communication with the vehicle-mounted device mounted on the vehicle; and
an administration device configured to communicate with the first roadside apparatus and the second roadside apparatus, wherein
the first roadside apparatus and the second roadside apparatus acquire, when a vehicle passes through communicable ranges of the respective roadside apparatuses, vehicle identification information for identifying the vehicle, and
the administration device stores the vehicle identification information acquired by the first roadside apparatus in a storage unit, decides whether the vehicle identification information acquired by the second roadside apparatus is included in the vehicle identification information stored in the storage unit, and provides the vehicle with reverse-way traveling warning information via the second roadside apparatus when the vehicle identification information acquired by the second roadside apparatus is not included in the vehicle identification information stored in the storage unit.

2. The road-vehicle communication system according to claim 1, wherein the administration device deletes, when the vehicle identification information acquired by the second roadside apparatus is included in the vehicle identification information stored in the storage unit, the vehicle identification information from the storage unit.

3. The road-vehicle communication system according to claim 1,
wherein the first roadside apparatus is installed in an entrance of an entering path for entering a parking area from the main lane of the toll road,
and the second roadside apparatus is installed in an exit of the entering path.

4. The road-vehicle communication system according to claim 3,
wherein the first roadside apparatus acquires, when a vehicle passes through the communicable range, vehicle type information for specifying a type of the vehicle, and
the administration device stores the vehicle identification information and the vehicle type information acquired by the first roadside apparatus, defines a type of the vehicle on the basis of the vehicle type information, and provides the vehicle with leading guide information corresponding to the vehicle when the vehicle identification information acquired by the second roadside apparatus is included in the vehicle identification information acquired from the first roadside apparatus.

5. The road-vehicle communication system according to claim 1, wherein the second roadside apparatus is configured to include the administration device.

6. The road-vehicle communication system according to claim 1, wherein the vehicle identification information or the vehicle type information is stored in the vehicle-mounted device mounted on the vehicle.
